(19) United States
(12) Patent Application Publication
(10) Pub. No.: US 2014/0119398 A1
(43) Pub. Date: May 1, 2014

(54) METHOD AND APPARATUS FOR DETERMINING AN OPERATING TEMPERATURE OF AN ELECTRIC MOTOR

(71) Applicant: DIEHL AKO STIFTUNG & CO. KG, Wangen (DE)

(72) Inventors: RADU LIVIU FLOREA, POMMELSBRUNN (DE); MARTIN WEINMANN, BAD WALDSEE (DE)

(73) Assignee: DIEHL AKO STIFTUNG & CO. KG, Wangen (DE)

(21) Appl. No.: 14/064,359

(22) Filed: Oct. 28, 2013

(30) Foreign Application Priority Data
Oct. 26, 2012 (DE) 102012021020.5

(51) Int. Cl. G01K 15/00

(52) U.S. Cl. CPC G01K 15/005
USPC 374/1

(57) ABSTRACT

In order to determine an operating temperature of an electric motor which is fed via an inverter, the inverter is first of all permanently assigned to an electric motor. Following calibration of measured value of at least one operating parameter of the electric motor by the assigned inverter on the production line of the electric motor and inverter, at least one measured value of at least one operating parameter of the electric motor is then acquired by the assigned inverter during operation of the electric motor and the operating temperature of the electric motor is determined using this at least one measured value and the calibration result from the assigned inverter.

### CROSS-REFERENCE TO RELATED APPLICATION

This application claims the priority, under 35 U.S.C. §119, of German application DE 10 2012 021 020.5, filed Oct. 26, 2012; the prior application is herewith incorporated by reference in its entirety.

### BACKGROUND OF THE INVENTION

### Field of the Invention

The present invention relates to a method and an apparatus for determining an operating temperature of an electric motor, in particular a drive motor of an electrical household appliance.

Ever higher demands are imposed on the electric motors in electrical household appliances. For example, the drive motors of washing drums of laundry treatment appliances are operated at ever higher speeds and with ever shorter idle times in order to shorten the program runtimes and reduce the energy and water consumption. However, in this case, it should be borne in mind that an operating temperature of the electric motor must not exceed a predefined limit temperature.

Additional temperature-sensitive protective circuits or temperature sensors connected to protective circuits, for example, may be integrated in the motor windings as overheating protection for the electric motor. However, these measures are generally too cost-intensive for large numbers of pieces as are conventional in electrical household appliances.

Published, non-prosecuted German patent application DE 103 61 405 A1 describes a laundry treatment appliance having a control arrangement for operating an electric motor, in which the control arrangement has means for acquiring an operating value of the motor. The control arrangement operates the motor in such a manner that the operating temperature of the motor does not exceed a predetermined limit value, the operating temperature being able to be determined from an average value and/or a sum value of the acquired operating value of the motor.

Published, non-prosecuted German patent application DE 101 19 201 A1, corresponding to U.S. Pat. No. 6,949,945, proposes the practice of calculating a temperature change of the motor windings from a change in the current flow through a motor winding using a change in the temperature-dependent resistance.

Published, non-prosecuted German patent application DE 103 31 934 B3 discloses a washing machine motor, the control device of which uses a motor model to control the motor, which model uses a temperature-based variable.

### SUMMARY OF THE INVENTION

The invention is based on the object of providing improved overheating protection for an electric motor fed by an inverter.

The object is achieved by a method for determining an operating temperature of an electric motor and an apparatus for determining an operating temperature of an electric motor. The respective subclaims relate to particularly preferred refinements and developments of the invention.

The method according to the invention for determining an operating temperature of an electric motor which is fed via an inverter has the following steps of:

(a) assigning an inverter to an electric motor;
(b) calibrating measured value acquisition of at least one operating parameter of the electric motor by the assigned inverter;
(c) acquiring at least one measured value of at least one operating parameter of the electric motor by the assigned inverter; and
(d) determining the operating temperature of the electric motor using the at least one measured value and the calibration result from the assigned inverter.

The present invention is based on the basic idea of assigning an inverter to an electric motor. In other words, a fixed unit, that is to say a unit which remains together during the service life or lifetime of the components, is formed from an electric motor and an inverter. In this context, this feature of remaining together can be understood as meaning not only an electrical and/or mechanical connection of the components but also a purely organizational link.

Such a paired assignment which is fixed over the entire service life of the two components makes it possible to adjust or adapt the inverter to the electric motor. In particular, measured value acquisition of at least one operating parameter of the electric motor can be calibrated by the inverter in order to thus attain more accurate results when determining the operating temperature. In particular, it is possible to achieve the situation in this case in which production tolerances of the components (for example electric motor, electronics of the inverter, etc.) do not influence or at least do not considerably influence the determination of the operating temperature.

While the components are being used as intended, the method according to the invention requires no additional protective circuits and also no temperature sensors, with the result that the structure of the inverter and of the electric motor can be simplified and their production costs can be reduced. In comparison with the use of a motor model for determining the operating temperature of the electric motor, less computation power is also required in the method according to the invention.

In this context, the electric motor is preferably an asynchronous motor, a synchronous motor or a universal motor. The electric motor is preferably a three-phase or polyphase electric motor, the winding phases of which are preferably connected to form a star.

In this context, the operating parameters of the electric motor include, in particular, the operating temperature and the winding resistance of the electric motor. In this context, further operating parameters of the electric motor may also be the consumed power, the supplied power, the speed and the like of the electric motor. If a plurality of, that is to say two, three or more, operating parameters of the electric motor are intended to be used, these operating parameters may be independent of one another or may be associated in some way. For example, the winding resistance increases with increasing operating temperature of the electric motor.

In this context, the calibration result may be any type of mathematical link which is suitable for correcting a measured value to the actual value for the respective operating parameter. In this context, the calibration result preferably includes simple correction factors, correction formulae, correction tables, correction matrices and the like, each individually or multiply for different operating parameters which are involved.

In acquisition step (c), the intention is to acquire at least one measured value of an operating parameter. In this case, the term “acquisition” is intended to be understood as meaning any desired manner of directly or indirectly determining the measured value of the respective operating parameter. The measured value of an operating parameter (for example resistance) is preferably indirectly determined by measuring measured values of other operating variables (for example current and voltage). Alternatively, an operating parameter may also be directly measured.

In determination step (d), the intention is to determine the operating temperature of the electric motor using the at least one measured value and the calibration result. In this context, the term “determination” is intended to be understood as meaning any type of evaluation which can be used to determine the operating temperature from the at least one measured value. These are preferably single calculation steps or a plurality of calculation steps. In this case, the type of calculation steps depends not least on the type of calibration result and the operating parameters used.

In this context, the operating parameters, the measured values of which are calibrated in calibration step (b), and the operating parameters, the measured values of which are acquired in acquisition step (c), need not necessarily match in terms of their numbers or types. In one preferred refinement of the invention, the measured value acquisition of one or two operating parameters (for example operating temperature and/or winding resistance) is calibrated, but only the measured value of one operating parameter (for example winding resistance) is acquired.

The method according to the invention for determining the operating temperature of an electric motor may consist solely of steps (a) to (d) stated above or may also have additional method steps before, between and/or after steps (a) to (d) stated above.

In one preferred refinement of the invention, the assignment step (a) and the calibration step (b) are carried out on a production line of the electric motor and inverter. Alternatively or additionally, it is also possible to carry out or repeat these steps during the service life of the components.

In one preferred refinement of the invention, the acquisition step (c) and/or the determination step (d) is/are carried out by a control device of the inverter. This control device of the inverter preferably has a microcontroller.

In another preferred refinement of the invention, in the calibration step (b), a reference value of at least one operating parameter of the electric motor is first of all measured and a reference measured value of at least one operating parameter of the electric motor is acquired by the assigned inverter, and the calibration result is then obtained by comparing the at least one reference measured value with the at least one reference value. The at least one reference value is preferably measured directly by a highly precise measuring apparatus. In this context, the comparison of the reference value and the reference measured value comprises the calculation of simple ratios of these values but also more complex calculations of correction factors, correction matrices and the like.

In the calibration step (b), the measured value acquisition of a winding resistance of the electric motor is preferably calibrated. For this purpose, the winding resistance and/or the operating temperature of the electric motor is/are preferably measured in order to obtain corresponding calibration results.

Before carrying out the calibration step (b), the electric motor is preferably stabilized to the ambient temperature in order to avoid distortion of the measurement results.

In yet another preferred refinement of the invention, the operating temperature of the electric motor is determined in determination step (d) by a calculation from a measured value of the winding resistance of the electric motor, which is corrected using the calibration result, or by correcting the measured value of the operating temperature of the electric motor, which is calculated from the measured value of the winding resistance, using the calibration result.

The above-described method of the invention for determining an operating temperature of an electric motor is preferably used in a method for controlling an inverter, which feeds an electric motor, on the basis of an operating temperature of the electric motor. In order to achieve the overheating protection for the electric motor, the inverter is preferably controlled in such a manner that the operating temperature of the electric motor does not exceed a predefined limit value. For this purpose, the inverter is preferably controlled in such a manner that the electric motor is switched off or its speed is reduced if the operating temperature reaches or exceeds the predefined limit value.

The apparatus according to the invention for determining an operating temperature of an electric motor which is fed via an inverter has: an acquisition apparatus for acquiring at least one measured value of at least one operating parameter of the electric motor by an inverter assigned to the electric motor; a calibration apparatus for calibrating measured value acquisition of at least one operating parameter of the electric motor by the assigned inverter; and an evaluation apparatus for determining the operating temperature of the electric motor using the at least one measured value and the calibration result from the assigned inverter. The apparatus of the invention is preferably suitable or designed for carrying out the above-described method of the invention.

With respect to the advantages, definitions of terms and preferred refinements of this apparatus according to the invention, the same statements as those made above in connection with the method according to the invention apply, and so these statements are not repeated at this juncture.

In one preferred refinement of the invention, a production line of the electric motor and inverter has a measuring apparatus for measuring at least one operating parameter of the electric motor on the production line.

In another preferred refinement of the invention, the inverter has a communication interface for communicating with the production line. The inverter can preferably be informed of the measurement result from the measuring apparatus of the production line via the communication interface. The inverter and its control apparatus can also preferably communicate, that is to say interchange data and control signals, with an external controller, for example the main controller of an electrical household appliance, via this communication interface.

In yet another preferred refinement of the invention, the calibration apparatus and the evaluation apparatus are formed by a control device of the inverter.

In yet another preferred refinement of the invention, the inverter has a memory for storing the calibration result.

The invention also relates to an electrical household appliance having a drive motor, which is fed via an inverter, and an apparatus for determining an operating temperature of the electric motor according to the present invention.

The invention also relates to an electrical household appliance having a drive motor, which is fed via an inverter, and a control apparatus which is configured to carry out the above-described method of the invention.

The household appliance is preferably a laundry treatment appliance (washing machine, tumble dryer, etc.), a dishwasher or the like.

Other features which are considered as characteristic for the invention are set forth in the appended claims.

Although the invention is illustrated and described herein as embodied in a method and an apparatus for determining an operating temperature of an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The single FIGURE of the drawing is a schematic illustration of an electric motor with an assigned inverter according to the invention.

### DETAILED DESCRIPTION OF THE INVENTION

Referring now to the single FIGURE of the drawing in detail there is shown an electric motor 10. The electric motor 10 is, for example, a drive motor of an electrical household appliance, for example a drive motor of a washing drum of a laundry treatment appliance (for example washing machine, tumble dryer) or a water pump of a dishwasher.

The electric motor 10 is assigned an inverter 12 which feeds the electric motor 10. This assignment between the electric motor 10 and the inverter 12 is carried out on the production line of the two components 10, 12 and remains over the service life or lifetime of these components. In other words, a fixed, permanent pair (in the organizational sense) is formed from the electric motor 10 and the inverter 12.

In this exemplary embodiment, the inverter 12 has a mains connection 121, a rectifier 122, a power module 123, an output connection 124, a control device 125, a current measuring apparatus 126, a measuring amplifier 127, a voltage measuring apparatus 128 and a communication interface 129. In addition, a temperature measuring device 141 and a resistance measuring device 142 (as the measuring apparatus of the invention) are provided on a production line 14 of the electric motor 10 and inverter 12.

The rectifier 122 contains a rectifier circuit for converting the AC voltage applied to the mains connection 121 into a DC voltage and an intermediate circuit.

The power module 123 is adjusted to the drive motor 10. In the case of a three-phase drive motor 10, for example, the power module 123 contains, for example, three half-bridges each having two power semiconductor switches and an associated driver. In this case, the inverter 12 feeds, for example, the three windings of the drive motor 10 which are connected in a star via the output connection 124.

The current measuring apparatus 126 is configured to acquire a motor current of one winding of the drive motor 10 or the motor currents of two or three windings of the drive motor 10. The acquired current values are supplied to the control device 125 of the inverter 12 via the measuring amplifier 127.

The voltage measuring apparatus 128 is configured to acquire the DC voltage of the intermediate circuit of the rectifier 122, which voltage is applied to the power module 123. The acquired voltage value is likewise supplied to the control device 125 of the inverter 12.

The control device 125 of the inverter 12 has, for example, a microcontroller which is configured and programmed to calculate a resistance value of one or more windings of the drive motor 10 from the current and voltage values supplied by the current measuring apparatus 126 and the voltage measuring apparatus 128. The current measuring apparatus 126, the measuring amplifier 127 and the voltage measuring apparatus 128 form, together with the microcontroller 125, the acquisition apparatus of the invention. The control device 125 also contains a memory for storing a calibration result explained below.

The communication interface 129 of the inverter 12 is used to interchange data and control signals between the control device 125 of the inverter 12 and an external device, for example the main controller of the household appliance. In addition, the inverter 12 is also connected to the production line 14 via this communication interface 129. The production line 14 can therefore transmit, for example, the reference values measured by the measuring devices 141, 142 to the control device 125 of the inverter 12.

The production line 14 of the electric motor 10 and inverter 12 has a highly accurate temperature measuring apparatus (for example thermometer) 141 for measuring the operating temperature (for example winding temperature) of the electric motor 10 and optionally also a highly accurate resistance measuring apparatus (for example ohmmeter) 142 for measuring the winding resistance or winding resistances of the electric motor 10.

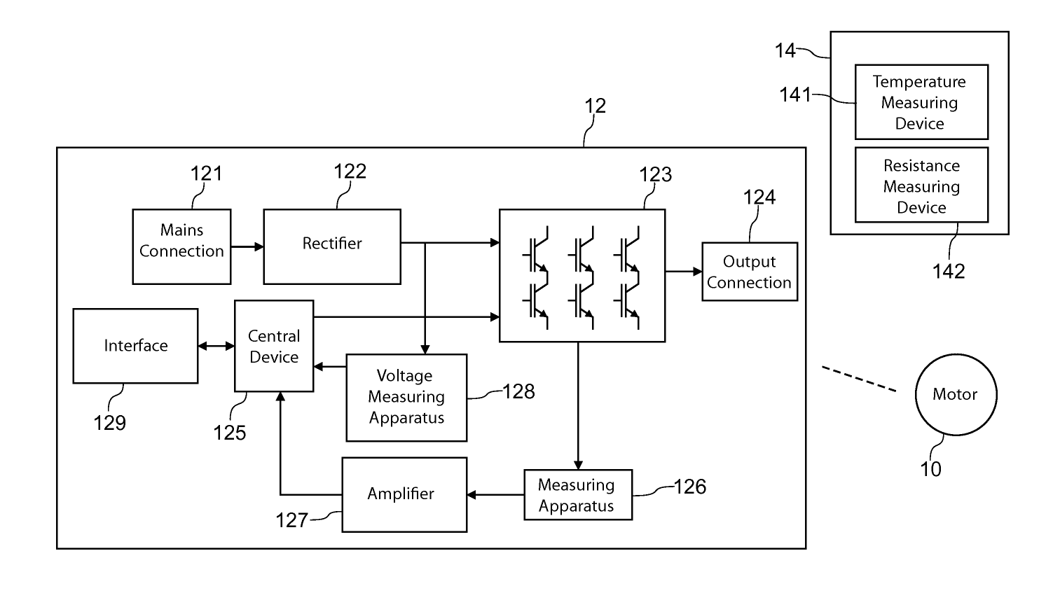

It is pointed out, as a precaution, that the electric motor 10, inverter 12 and production line 14 are each illustrated only in a highly simplified manner in FIG. 1. It goes without saying that these components may have further parts, apparatuses, connections, etc.

For the overheating protection of the electric motor 10 during its operation or intended use, its operating temperature (for example winding temperature) T must be monitored. The inverter 12 feeds the electric motor 10 in such a manner that its operating temperature T does not exceed a predefined limit value. For example, the electric motor 10 can be switched off or its speed can be reduced if the operating temperature T reaches or exceeds the predefined limit value.

For this purpose, the operating temperature of the electric motor 10 is monitored during its operation. The method used here for determining the operating temperature T of the electric motor 10 is based on measuring a winding resistance R of the electric motor 10 by the inverter 12. The operating or winding temperature T of the electric motor 10 can be determined from the winding resistance R with the aid of the following formula:

$$i . T = {T}_{0} + \frac{1}{α} ( \frac{R}{{R}_{0}} - 1 ) \qquad ( 1 )$$

where T: operating or winding temperature
(b) T₀: reference temperature
(c) R: winding resistance at T
(d) R₀: reference resistance at T0 (e.g. cold resistance)
(e) α: temperature coefficient of the winding material.

In order to be able to determine the operating temperature T of the electric motor 10 with a high degree of accuracy during operation, an electric motor 10 and an inverter 12 are already assigned to one another on the production line, that is to say during production. This pair of the electric motor 10 and inverter 12 then permanently remains together, preferably over the entire service life or lifetime of the two components. This feature of remaining together generally means a permanent, organizational assignment and not necessarily a permanent mechanical and/or electrical connection between the two components.

A first exemplary embodiment of a method according to the invention for determining the operating temperature of the electric motor is now described in more detail.

As already mentioned above, the inverter 12 is first of all assigned to an electric motor 10. This is preferably already affected on the production line, for example at the end of the production process.

Before the calibration process of the inverter 12 begins, the temperature of the electric motor 10 should have stabilized to the ambient temperature of the production line 14 in order to avoid distorted measurement and calibration results.

In a first step, the resistance measuring apparatus 142 of the production line 14 is connected to the electric motor 10. The resistance measuring apparatus 142 measures a reference value Rref of the winding resistance of the electric motor 10. This reference value Rref is transmitted from the production line 14 to the inverter 12 via its communication interface 129. This reference value is permanently stored in the control apparatus 125 of the inverter 12.

In a second step, the electric motor 10 is connected to the output connection 124 of the inverter 12. The production line 14 controls the inverter 12, via its communication interface 129, to carry out a resistance measurement.

For this resistance measurement, the current measuring apparatus 126 measures a current I through a winding of the electric motor 10 and the voltage measuring apparatus 128 measures the intermediate circuit voltage U of the rectifier 122. The control apparatus 125 of the inverter 12 calculates a reference measured value Rrefm=U/I of the winding resistance of the electric motor 10 from these measured values I, U which are possibly also amplified.

In a third step, the inverter 12 carries out self-calibration. The control apparatus 125 of the inverter determines a calibration result K on the basis of the reference value Rref from the resistance measuring apparatus 142 of the production line 14 and the reference measured value Rrefm from the inverter 12. This calibration result K is permanently stored in the control apparatus 125 of the inverter 12. In the simplest case, the calibration result K is determined by the ratio Rref/Rrefm.

The operating temperature T of the electric motor 10 with the inverter 12 assigned and adjusted to the latter can now be determined at any desired time with a high degree of accuracy by acquiring the winding resistance of the electric motor 10 by the inverter 12 as follows.

A measured value Rm of the winding resistance of the electric motor 10 is also calculated during operation, in a similar manner to that in the above calibration process, by the inverter 12 from the current I through the winding and the intermediate circuit voltage U which are acquired with the aid of the current measuring apparatus 126, 127 and the voltage measuring apparatus 128 of the inverter 12.

The measured value Rm of the winding resistance of the electric motor is then corrected using the previously determined calibration result K stored in the control device 125. For example, the value R of the winding resistance of the electric motor results from R=K×Rm.

The control device 125 of the inverter 12 can then calculate the operating temperature T of the electric motor 10 from the value R of the winding resistance, which is determined in this manner, using the above equation (1). On account of the fact that the measured value Rm of the winding resistance, which is acquired by the inverter 12, is corrected using the calibration result K determined on the production line, the operating temperature T of the electric motor 10 can be determined with a very high degree of accuracy. The fixed assignment between the electric motor 10 and the inverter 12 and the calibration of the measured value acquisition of the inverter 12 make it possible, in particular, to reduce or even minimize or avoid influence of production tolerances of the involved components 10, 12 and their parts on the determination result of the operating temperature.

A second exemplary embodiment of a method according to the invention for determining the operating temperature of the electric motor is now described in more detail.

Like in the first exemplary embodiment, an inverter 12 is first of all assigned to an electric motor 10. This is preferably already affected on the production line, for example at the end of the production process.

Before the calibration process of the inverter 12 begins, the temperature of the electric motor 10 should have stabilized to the ambient temperature of the production line 14 in order to avoid distorted measurement and calibration results.

In a first step, the temperature measuring apparatus 141 and the resistance measuring apparatus 142 of the production line 14 are connected to the electric motor 10. The temperature measuring apparatus 141 measures a reference value Tref of the operating or winding temperature of the electric motor 10 and the resistance measuring apparatus 142 measures a reference value Rref of the winding resistance of the electric motor 10. These reference values Tref, Rref are transmitted from the production line 14 to the inverter 12 via its communication interface 129. These reference values are permanently stored in the control apparatus 125 of the inverter 12.

In a second step, the electric motor 10 is connected to the output connection 124 of the inverter 12. The production line 14 controls the inverter 12, via its communication interface 129, to carry out a resistance measurement.

Like in the first exemplary embodiment, for this resistance measurement, the current measuring apparatus 126 measures a current I through a winding of the electric motor 10 and the voltage measuring apparatus 128 measures an intermediate circuit voltage U of the rectifier 122. The control apparatus 125 of the inverter 12 calculates a reference measured value Rrefm=U/I of the winding resistance of the electric motor 10 from these measured values I, U which are possibly also amplified. In this exemplary embodiment, the control apparatus 125 additionally calculates a reference measured value Trefm for the operating temperature of the electric motor 10 from this reference measured value Rrefm of the winding resistance with the aid of the above equation (1).

In a third step, the inverter 12 carries out self-calibration. The control apparatus 125 of the inverter determines a first calibration result Kr on the basis of the reference value Rref from the resistance measuring apparatus 142 of the production line 14 and the reference measured value Rrefm from the inverter 12. This first calibration result Kr is permanently stored in the control apparatus 125 of the inverter 12. In the simplest case, the first calibration result Kr is determined by the ratio Rref/Rrefm.

In this exemplary embodiment, the control apparatus 125 of the inverter 12 additionally determines a second calibration result Kt on the basis of the reference value Tref from the temperature measuring apparatus 141 of the production line 14 and the calculated reference measured value Trefm from the inverter 12. This second calibration result Kt is likewise permanently stored in the control apparatus 125 of the inverter 12. In the simplest case, the second calibration result Kt is determined by the ratio Tref/Trefm.

The operating temperature T of the electric motor 10 with the inverter 12 assigned and adjusted to the latter can now be determined at any desired time with a high degree of accuracy by acquiring the winding resistance of the electric motor 10 by the inverter 12 as follows.

In the second exemplary embodiment as well, a measured value Rm of the winding resistance of the electric motor 10 is calculated by the inverter 12 from the current I through the winding and the intermediate circuit voltage U which are acquired with the aid of the current measuring apparatus 126, 127 and the voltage measuring apparatus 128 of the inverter 12.

The measured value Rm of the winding resistance of the electric motor is then corrected using the previously determined first calibration result Kr stored in the control device 125. For example, the value R of the winding resistance of the electric motor results from R=Kr×Rm.

The control device 125 of the inverter 12 can then calculate a value Tm for the operating temperature of the electric motor 10 from the value R of the winding resistance, which is determined in this manner, using the above equation (1). In contrast to the above first exemplary embodiment, the determined value Tm of the operating temperature is now also corrected in this exemplary embodiment using the previously determined second calibration result Kt stored in the control device 125. For example, the value T of the operating temperature of the electric motor results from T=Kt×Tm.

On account of the fact that the measured value Rm of the winding resistance, which is acquired by the inverter 12, and the determined value Tm of the operating temperature are corrected using the calibration result Kr, Kt determined on the production line, the operating temperature T of the electric motor 10 can be determined with a very high degree of accuracy.

A third exemplary embodiment of a method according to the invention for determining the operating temperature of the electric motor is now described in more detail.

Like in the above exemplary embodiments, an inverter 12 is first of all assigned to an electric motor 10. This is preferably already effected on the production line, for example at the end of the production process.

Before the calibration process of the inverter 12 begins, the temperature of the electric motor 10 should have stabilized to the ambient temperature of the production line 14 in this case too in order to avoid distorted measurement and calibration results.

In a first step, the temperature measuring apparatus 141 of the production line 14 is connected to the electric motor 10. The temperature measuring apparatus 141 measures a reference value Tref of the operating or winding temperature of the electric motor 10. This reference value Tref is transmitted from the production line 14 to the inverter 12 via its communication interface 129. This reference value is permanently stored in the control apparatus 125 of the inverter 12.

In a second step, the electric motor 10 is connected to the output connection 124 of the inverter 12. The production line 14 now controls the inverter 12, via its communication interface 129, to carry out a resistance measurement.

Like in the above exemplary embodiments, for this resistance measurement, the current measuring apparatus 126 measures a current I through a winding of the electric motor 10 and the voltage measuring apparatus 128 measures an intermediate circuit voltage U of the rectifier 122. The control apparatus 125 of the inverter 12 calculates a reference measured value Rrefm=U/I of the winding resistance of the electric motor 10 from these measured values I, U which are possibly also amplified. In this exemplary embodiment, the control apparatus 125 additionally calculates a reference measured value Trefm for the operating temperature of the electric motor 10 from this reference measured value Rrefm of the winding resistance with the aid of the above equation (1).

In a third step, the inverter 12 carries out self-calibration. The control apparatus 125 of the inverter determines a calibration result K on the basis of the reference value Tref from the temperature measuring apparatus 141 of the production line 14 and the calculated reference measured value Trefm from the inverter 12. This calibration result K is permanently stored in the control apparatus 125 of the inverter 12. In the simplest case, the calibration result K is determined by the ratio Tref/Trefm.

The operating temperature T of the electric motor 10 with the inverter 12 assigned and adjusted to the latter can now be determined at any desired time with a high degree of accuracy by acquiring the winding resistance of the electric motor 10 by the inverter 12 as follows.

In this third exemplary embodiment as well, a measured value Rm of the winding resistance of the electric motor 10 is calculated by the inverter 12 from the current I through the winding and the intermediate circuit voltage U which are acquired with the aid of the current measuring apparatus 126, 127 and the voltage measuring apparatus 128 of the inverter 12.

The control device 125 of the inverter 12 then calculates a measured value Tm for the operating temperature of the electric motor 10 from this measured value Rm of the winding resistance using the above equation (1). This measured value Tm is then corrected using the previously determined calibration result K stored in the control device 125. For example, the value T of the operating temperature of the electric motor results from T=K×Tm.

On account of the fact that the measured value Tm of the operating temperature, which is calculated by the inverter 12, is corrected using the calibration result K determined on the production line, the operating temperature T of the electric motor 10 can be determined with a very high degree of accuracy.

A fourth exemplary embodiment of a method according to the invention for determining the operating temperature of the electric motor is now described in more detail.

Like in the above third exemplary embodiment, only the operating temperature of the electric motor 10 is used in this exemplary embodiment for self-calibration of the inverter 12. In this case, it is assumed that the inverter 12 has only a gain error ε during the resistance measurement, that is to say the measured value Rm of the winding resistance and the actual value R of the winding resistance of the electric motor 10 for any desired temperature are associated as follows:

i. Rm=ε×R (2)

In fact, however, the resistance measurement shows an additional offset. With conventional production tolerances of the components, this offset is of the order of magnitude of approximately 10 mΩ and is therefore disregarded.

The temperature dependence of the winding resistance can be expressed by the following equation:

a. Rm=R′₀[1+α(T−T₀)] (3)

where R′₀ denotes the reference resistance value R₀ which is influenced by production tolerances at the reference temperature T₀.

Combining equations (1), (2) and (3) gives the following for the operating temperature Tm determined by the inverter 12:

$$( i ) Tm = ɛ \frac{{R}_{0}^{′}}{{R}_{0}} T - ( ɛ \frac{{R}_{0}^{′}}{{R}_{0}} - 1 ) ( {T}_{0} - \frac{1}{α} ) \qquad ( 4 )$$

It can be discerned that the measured value Tm of the operating temperature in equation (4) is influenced by a gain error and an offset error which cannot be disregarded. The following calibration factor K, derived from equation (4), can be used for the calibration process:

$$a . Tm = ɛ \frac{{R}_{0}^{′}}{{R}_{0}} = \frac{Tm + \frac{1}{α} - {T}_{0}}{T + \frac{1}{α} - {T}_{0}} \qquad ( 5 )$$

Like in the above exemplary embodiments, the inverter 12 is first of all assigned to the electric motor 10. This is preferably already affected on the production line, for example at the end of the production process.

Before the calibration process of the inverter 12 begins, the temperature of the electric motor 10 should have stabilized to the ambient temperature of the production line 14 in this case too in order to avoid distorted measurement and calibration results.

In a first step, the temperature measuring apparatus 141 of the production line 14 is connected to the electric motor 10. Like in the above third exemplary embodiment, the temperature measuring apparatus 141 now measures a reference value Tref of the operating or winding temperature of the electric motor 10. The reference value Tref is transmitted from the production line 14 to the inverter 12 via its communication interface 129. The reference value is permanently stored in the control apparatus 125 of the inverter 12.

In a second step, the electric motor 10 is connected to the output connection 124 of the inverter 12. The production line 14 now controls the inverter 12, via its communication interface 129, to carry out a resistance measurement.

Like in the above exemplary embodiments, for the resistance measurement, the current measuring apparatus 126 measures a current I through a winding of the electric motor 10 and the voltage measuring apparatus 128 measures an intermediate circuit voltage U of the rectifier 122. The control apparatus 125 of the inverter 12 calculates a reference measured value Rrefm=U/I of the winding resistance of the electric motor 10 from these measured values I, U which are possibly also amplified. In this exemplary embodiment, the control apparatus 125 additionally calculates a reference measured value Trefm for the operating temperature of the electric motor 10 from the reference measured value Rrefm of the winding resistance with the aid of the above equation (1).

In a third step, the inverter 12 carries out self-calibration. The control apparatus 125 of the inverter determines a calibration result K on the basis of the reference value Tref from the temperature measuring apparatus 141 of the production line 14 and the calculated reference measured value Trefm from the inverter 12, which calibration result K is permanently stored in the control apparatus 125 of the inverter 12. In this exemplary embodiment, the calibration result K is calculated on the basis of the above equation (5) as follows:

$$i . K = \frac{Trefm + \frac{1}{α} - {T}_{0}}{Tref + \frac{1}{α} - {T}_{0}} \qquad ( 6 )$$

The operating temperature T of the electric motor 10 with the inverter 12 assigned and adjusted to the latter can now be determined at any desired time with a high degree of accuracy by acquiring the winding resistance of the electric motor 10 by the inverter 12 as follows.

In this fourth exemplary embodiment as well, a measured value Rm of the winding resistance of the electric motor 10 is again calculated by the inverter 12 from the current I through the winding and the intermediate circuit voltage U which are acquired with the aid of the current measuring apparatus 126, 127 and the voltage measuring apparatus 128 of the inverter 12.

The control device 125 of the inverter 12 then calculates a measured value Tm for the operating temperature of the electric motor 10 from this measured value Rm of the winding resistance using the above equation (1). This measured value Tm is then corrected using the previously determined calibration result K stored in the control device 125. In this exemplary embodiment, the value T of the operating temperature of the electric motor 10 then results from:

$$1. T = [ Tm - ( k - 1 ) ( \frac{1}{α} - {T}_{0} ) ] \frac{1}{k} \qquad ( 7 )$$

On account of the fact that the measured value Tm of the operating temperature, which is calculated by the inverter 12, is corrected using the calibration result K determined on the production line taking into account gain and offset errors, the operating temperature T of the electric motor 10 can be determined with a very high degree of accuracy.

In the third and fourth exemplary embodiments, the winding resistance is not measured by a resistance measuring apparatus 142 of the production line 14 in the calibration process. This makes it possible to reduce the production costs on the production line 14.

1. A method for determining an operating temperature of an electric motor being fed via an inverter, which comprises the steps of:
(a) assigning the inverter to the electric motor;
(b) calibrating a measured value acquisition of at least one operating parameter of the electric motor by means of the inverter;
(c) acquiring at least one measured value of at least one operating parameter of the electric motor by means of the inverter; and
(d) determining the operating temperature of the electric motor using the at least one measured value and a calibration result from the inverter.

2. The method according to claim 1, which further comprises carrying out the assigning step (a) and the calibrating step (b) on a production line of the electric motor and the inverter.

3. The method according to claim 1, which further comprises carrying out at least one of the acquiring step (c) or the determining step (d) via a control device of the inverter.

4. The method according to claim 1, which further comprises:
performing the calibrating step (b) by measuring a reference value of the at least one operating parameter of the electric motor;
acquiring a reference measured value of the at least one operating parameter of the electric motor by means of the inverter; and
obtaining the calibration result by comparing the reference measured value with the reference value.

5. The method according to claim 1, which further comprises:
determining the operating temperature of the electric motor by means of a calculation from the at least one measured value of a winding resistance of the electric motor, which is corrected using the calibration result, or by correcting a measured value of the operating temperature of the electric motor, which is calculated from the measured value of the winding resistance, using the calibration result.

6. A method for controlling an inverter feeding an electric motor, on a basis of an operating temperature of the electric motor, which comprises the steps of:
determining the operating temperature of the electric motor by the further steps of:
assigning the inverter to the electric motor;
calibrating a measured value acquisition of at least one operating parameter of the electric motor by means of the inverter;
acquiring at least one measured value of at least one operating parameter of the electric motor by means of the inverter; and
determining the operating temperature of the electric motor using the at least one measured value and a calibration result from the inverter.

7. An apparatus for determining an operating temperature of an electric motor, the apparatus comprising:
an inverter assigned to the electric motor, said inverter containing:
an acquisition apparatus for acquiring at least one measured value of at least one operating parameter of the electric motor by means of said inverter assigned to the electric motor;
a calibration apparatus for calibrating a measured value acquisition of at least one operating parameter of the electric motor by means of said inverter; and
an evaluation apparatus for determining the operating temperature of the electric motor using the at least one measured value and a calibration result from said inverter.

8. The apparatus according to claim 7,
further comprising a production line for the electric motor; and
wherein said inverter has a measuring apparatus for measuring at least one operating parameter of the electric motor on said production line.

9. The apparatus according to claim 8, wherein said inverter has a communication interface for communicating with said production line.

10. The apparatus according to claim 7, wherein said calibration apparatus and said evaluation apparatus are formed by a control device of said inverter.

11. The apparatus according to claim 7, wherein said inverter has a memory for storing the calibration result.

12. An electrical household appliance, comprising:
an inverter;
an electric motor being feed via said inverter;
an apparatus for determining an operating temperature of said electric motor, said apparatus containing:
an acquisition apparatus for acquiring at least one measured value of at least one operating parameter of said electric motor by means of said inverter assigned to said electric motor;
a calibration apparatus for calibrating a measured value acquisition of at least one operating parameter of said electric motor by means of said inverter; and
an evaluation apparatus for determining the operating temperature of said electric motor using the at least one measured value and a calibration result from said inverter.

13. An electrical household appliance, comprising:
an inverter;
an electric motor fed via said inverter;
a control apparatus for determining an operating temperature of said electric motor, said control apparatus programmed to:
assign said inverter to said electric motor;
calibrate a measured value acquisition of at least one operating parameter of said electric motor by means of said inverter;
acquire at least one measured value of at least one operating parameter of said electric motor by means of said inverter; and
determine the operating temperature of said electric motor using the at least one measured value and a calibration result from said inverter.
